(19) United States
(12) Patent Application Publication
(10) Pub. No.: US 2007/0196533 A1
(43) Pub. Date: Aug. 23, 2007

(54) MOLD FOR AN LED LAMPSHADE

(75) Inventors: Y-Ju Chen, Taipei (TW); Jing-Wen Tzeng, Tu Cheng, Taipei Hsien (TW)

Correspondence Address: PAI PATENT & TRADEMARK LAW FIRM, 1001 FOURTH AVENUE, SUITE 3200, SEATTLE, WA, 98154, US

(73) Assignee: TECHWIN OPTO-ELECTRONICS CO., LTD., Taipei Hsien (TW)

(21) Appl. No.: 11/308,671

(22) Filed: Apr. 20, 2006

(30) Foreign Application Priority Data
Feb. 21, 2006 (TW) 95202932

(51) Int. Cl. B29C 45/40

(52) U.S. Cl. 425/556; 425/577

(57) ABSTRACT

A mold for an LED lampshade comprising: an upper mold defined with a cavity in the bottom surface thereof; a lower mold defined with a slide recess corresponding to the cavity of the upper mold, a movable ejection block being received in the slide recess, the movable ejection block being movable back and forth along the slide recess, a cavity being defined in the top surface of the movable ejection block; and multiple ejection rods respectively disposed at the lower mold and at opposite sides of the movable ejection block and extending from the bottom of the lower mold to the top of the lower mold. When the mold of the present invention is used to injection mold, the LED lampshade is ejected by the movable ejection block in a manner of surface contact thereby preventing ejection marks on the surface of the LED lampshade.

### RELATED APPLICATIONS

The present application is based on, and claims priority from, Taiwan Application Serial Number 95202932, filed Feb. 21, 2006, the disclosure of which is hereby incorporated by reference herein in its entirety.

### FIELD OF THE INVENTION

The present invention relates to a mold for an LED (light emitting diode) lampshade, and particularly to a mold for an LED lampshade having a movable ejection block for enabling the LED lampshade to disengage from the mold without leaving marks on the LED lampshade.

### BACKGROUND OF THE INVENTION

In the conventional LED bulb manufacturing process, an LED lampshade is formed on a conveyer belt using injection molding to manufacture a roll of the LED lampshades. The roll of the LED lampshades is transferred to a packaging place to complete the subsequent manufacturing processes such as packing chip and so on.

FIG. 3 is a cross-sectional view of a conventional mold. The conventional mold mainly includes an upper mold 10′, a lower mold 20′ and multiple ejection rods 30′. When an LED lampshade is manufactured by injection molding, a closed mold state initially exists between the upper mold 10′ and the lower mold 20′, and a conveyer belt 62′ is disposed between the upper mold 10′ and the lower mold 20′, as shown in FIG. 4A. Melted plastic is then injected through an injection hole (not shown) into the space between the upper mold 110′ and the lower mold 20′ thereby forming the LED lampshade 60′ on the surface of the conveyer belt 62′, as shown in FIG. 4B. When the injection molding process for the manufacturing of the LED lampshade is completed, the upper mold 110′ and lower mold 20′ are opened and top ends of the ejection rods 30′ extends from the top surface of the lower mold 20′ to eject the lampshade 60′ out of the mold, as shown in FIGS. 4C-4E.

However, the ejection rods 30′ of a conventional mold are in contact with the surface of the LED lampshade 60′ during the injection molding process. When the LED lampshade is ejected from the mold, conventional ejection rods 30′ are in direct contact with the surface of the LED lampshade 60′. Therefore, an ejection mark 64′ may be formed on the surface of the LED lampshade 60′. These ejection marks 64′ adversely affect the surface of the LED lampshade 60′. Furthermore, since there is point contact between the ejection rods 30′ and the LED lampshade 60′ when the ejection rods 30′ eject the LED lampshade 60′, improper stress may occur on the surface of the LED lampshade 60′ which may result in slight deformations on distortions on the surface of the LED lampshade after the LED lampshade 60′ is released from the mold.

### SUMMARY OF THE INVENTION

An objective of the present invention is to provide a mold for an LED lampshade which can prevent ejection marks when the LED lampshade is being disengaged from the mold.

Another objective of the present invention is to provide a mold for an LED lampshade that ejects the LED lampshade with even stress on all surfaces when it is disengaged from the mold and thereby preventing deformation or damage on the surface of the LED lampshade caused by uneven stress.

To achieve the above objectives, the present invention provides a mold for an LED lampshade comprising: an upper mold with a cavity in the bottom surface thereof; a lower mold with a slide recess corresponding to the cavity of the upper mold, a movable ejection block received in the slide recess and movable back and forth along the slide recess, a cavity in the top surface of the movable ejection block, with the surface of the cavity of the movable eject block able to receive the lower surface of the LED lampshade; and multiple ejection rods respectively disposed on the lower mold, at opposite sides of the movable ejection block and extending from the bottom of the lower mold to the top of the lower mold. When the mold of the present invention is used to injection mold, the LED lampshade is ejected by the movable ejection block in a manner of surface contact thereby preventing ejection marks from forming on the surface of the LED lampshade and enabling the LED lampshade to be ejected with uniform stress exerted along the entire surface.

These and other embodiments, aspects and features of the invention will be better understood from a detailed description of the preferred embodiments of the invention, which are further described below in conjunction with the accompanying figures.

### BRIEF DESCRIPTION OF THE DRAWINGS

FIG. 1 is a cross sectional view of a mold of the present invention;

FIGS. 2A-2F are schematic views showing the injection molding operation using the mold of the present invention;

FIG. 3 is a cross sectional view of a conventional mold; and

FIGS. 4A-4E are schematic views showing the injection molding operation of the conventional mold.

### DETAILED DESCRIPTION OF THE PREFERRED EMBODIMENT

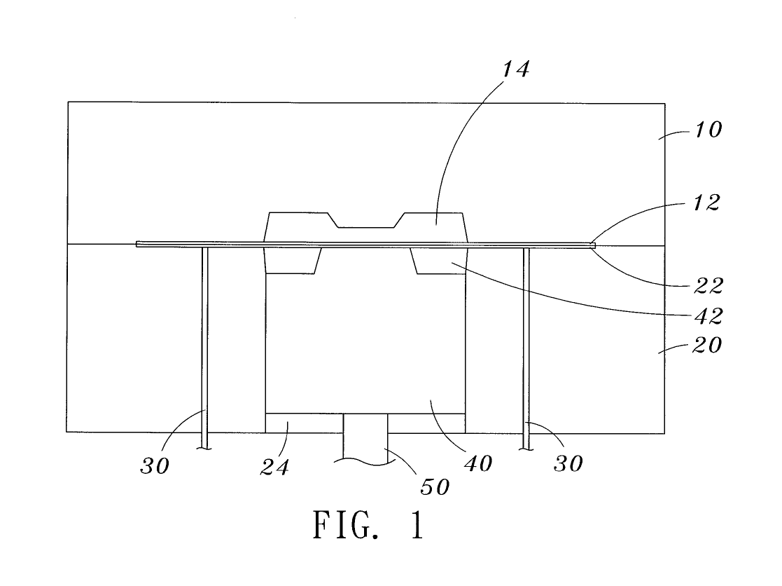

FIG. 1 is a cross sectional view of a mold of the present invention for forming an LED lampshade. As shown in FIG. 1, the mold of the present invention includes an upper mold 10, a lower mold 20 and multiple ejection rods 30, a movable ejection block 40 and a driving member 50. The bottom of the upper mold 10 is disposed in accordance with the top of the lower mold 20 to enable the LED lampshade to be formed by injection molding between the upper mold 10 and the lower mold 20.

Two grooves 12, 22 are respectively formed on the surfaces between the upper mold 10 and the lower mold 20 to receive a conveyer belt 62 for the LED lampshade. The cavity 14 is formed in the bottom of the upper mold 10 to receive injected plastic for injection molding.

A slide recess 24 is defined on the lower mold 20 corresponding to cavity 14 of the upper mold 10. The movable ejection block 40 is received in the slide recess 24. The driving member 50 is disposed at the bottom of the movable ejection block 40. The driving member 50 may drive the movable ejection block 40 to move back and forth in a direction perpendicular to the top of the lower mold 20 and along the slide recess 24. The driving member 50 may be an oil cylinder, an air cylinder or a spring. The top surface of the movable ejection block 40 is similarly defined with a cavity 42 corresponding to the cavity 14 of the upper mold 10 for receiving injected plastic for injection molding. The surface of the cavity 42 fittingly receives the lower surface of the LED lampshade 60.

The ejection rods 30 are respectively disposed on the lower mold 20, at opposite sides of the movable ejection block 40 and extend from the bottom of the lower mold 20 to the top of the lower mold 20.

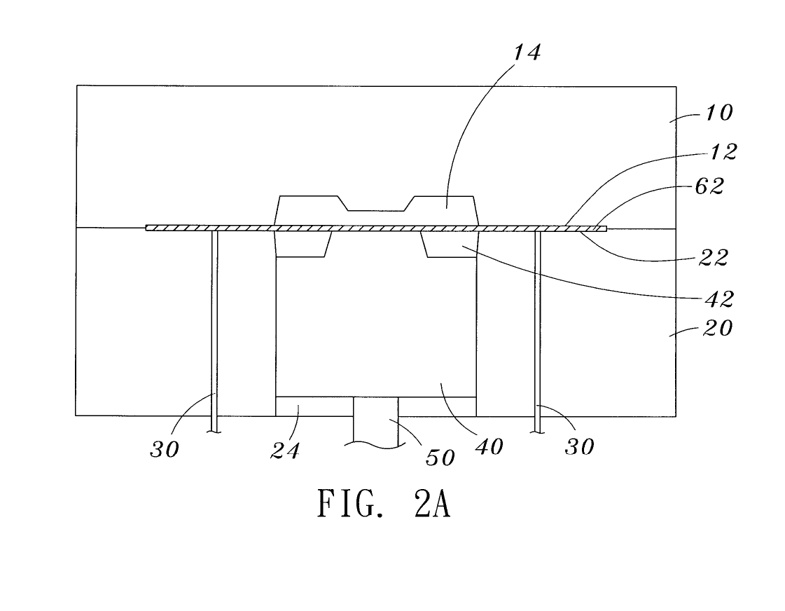

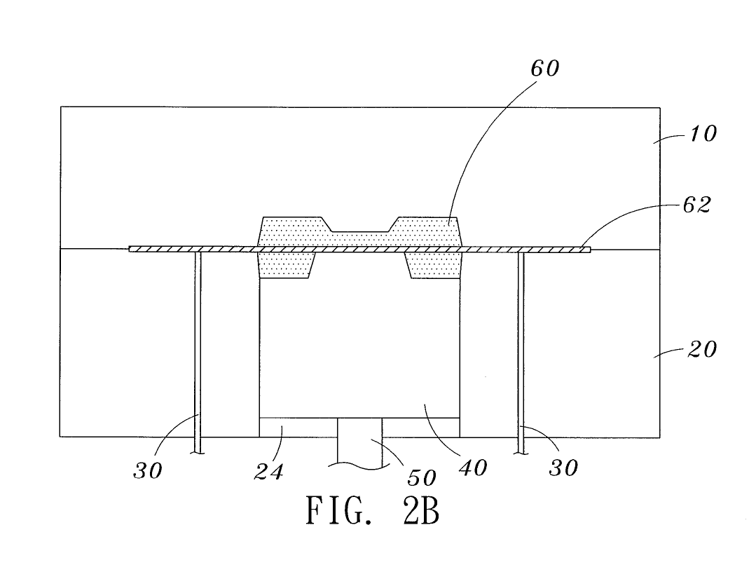

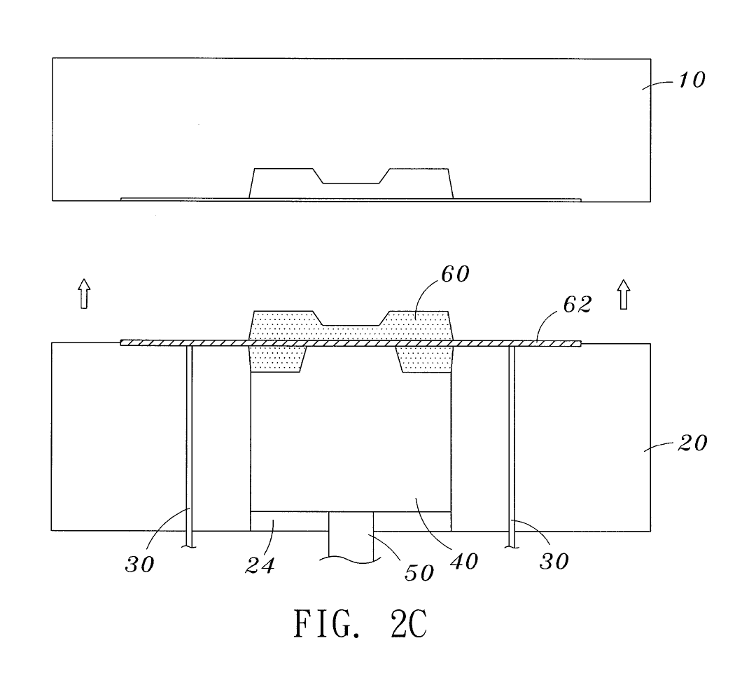

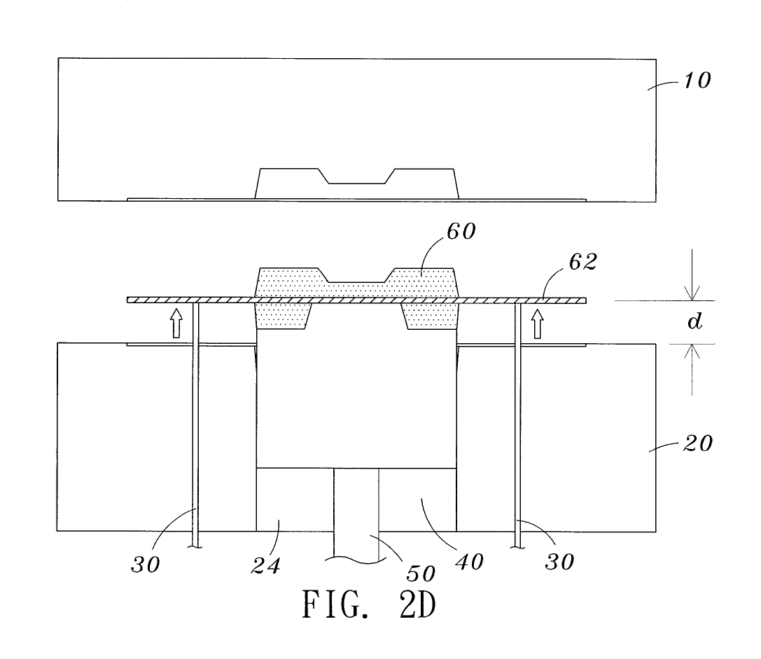

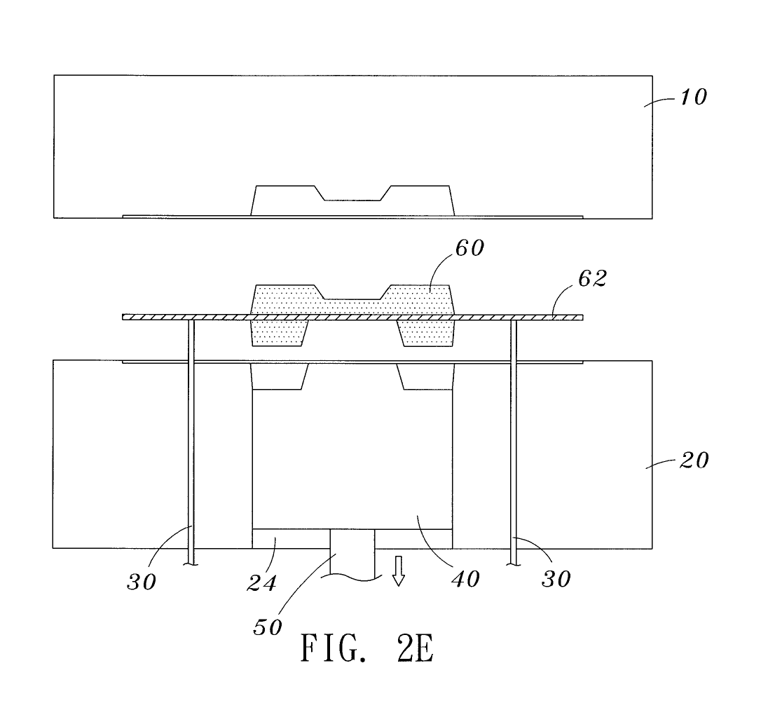

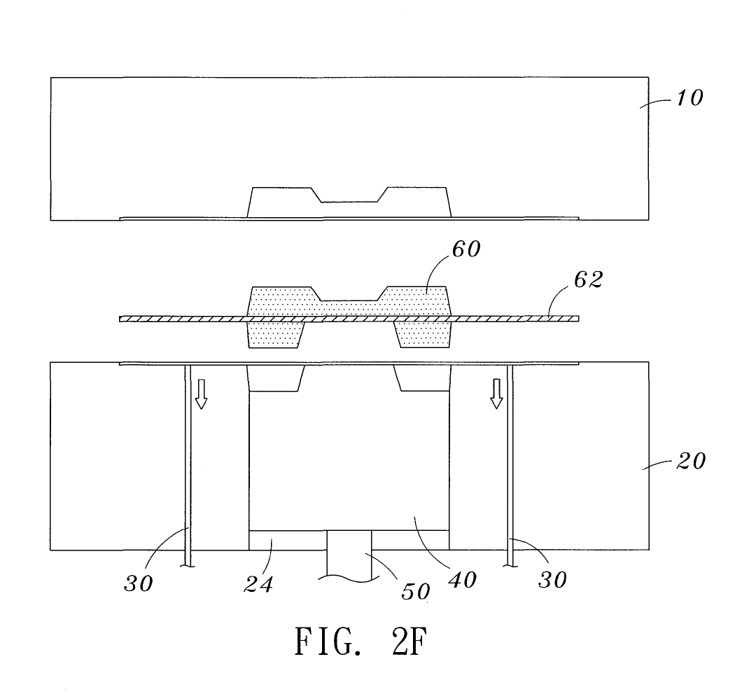

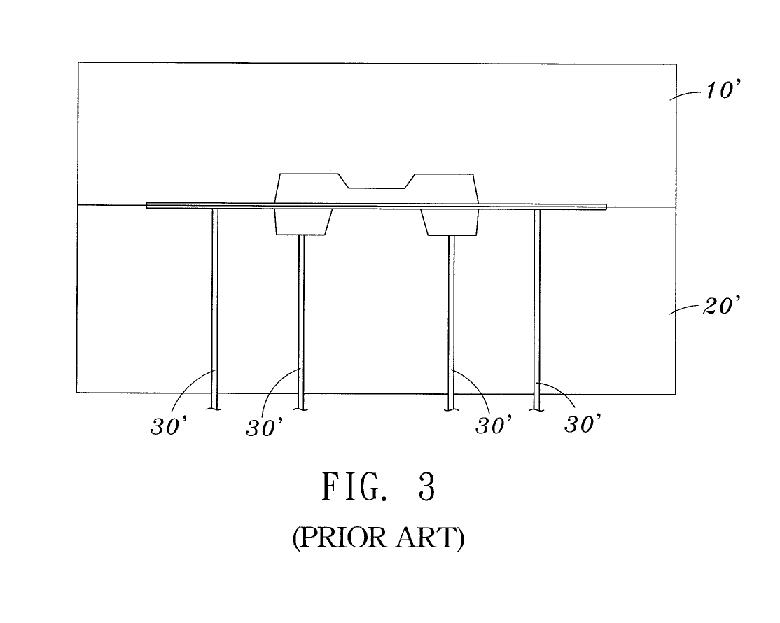

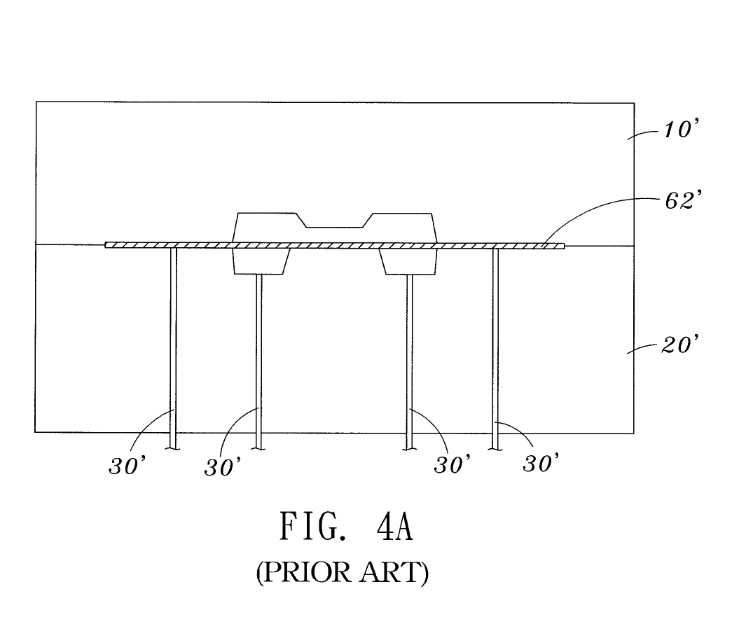

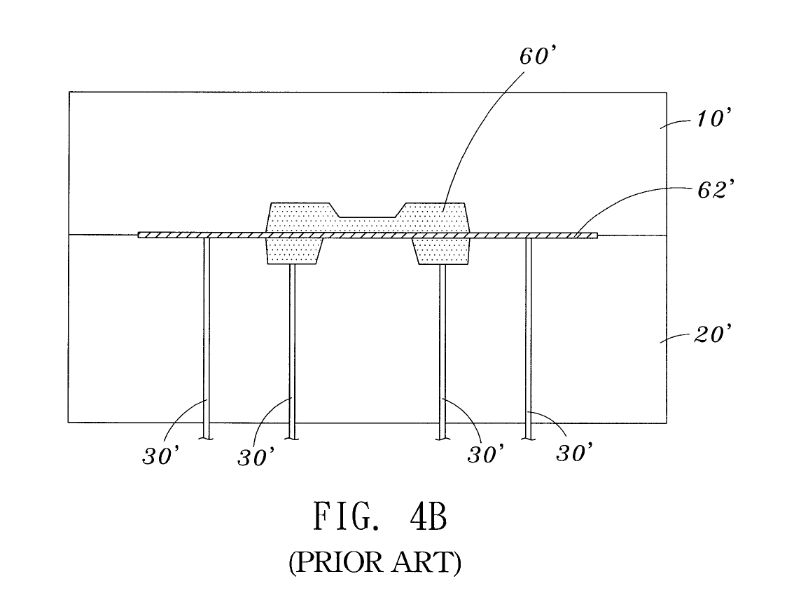

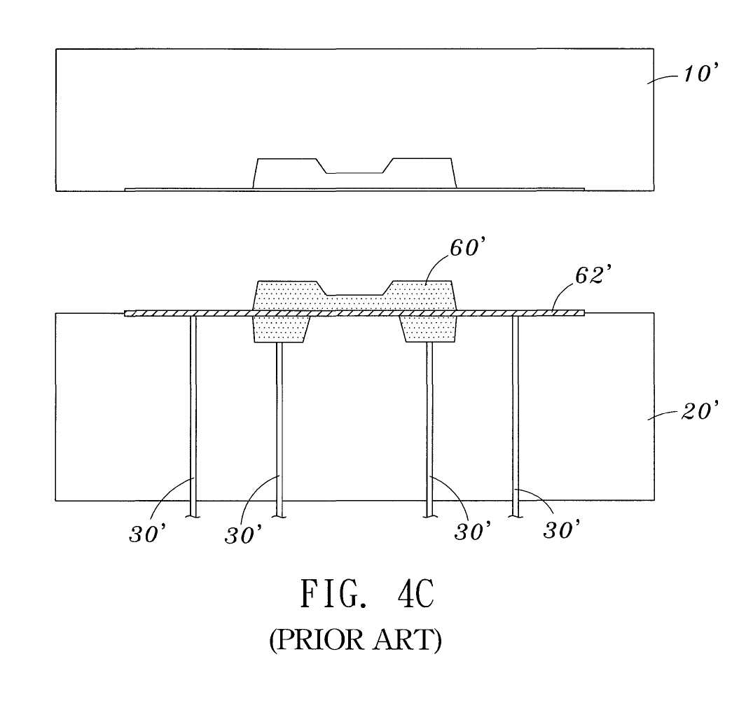

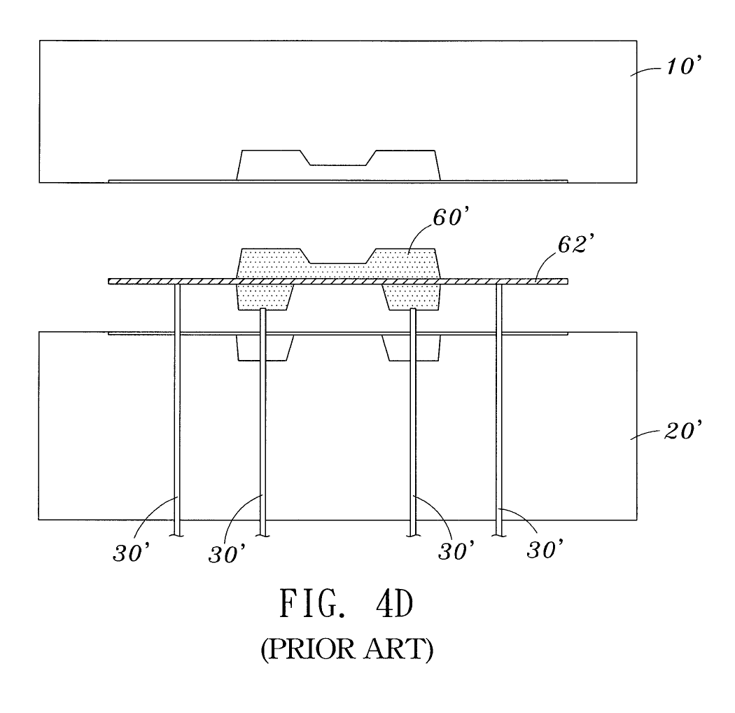

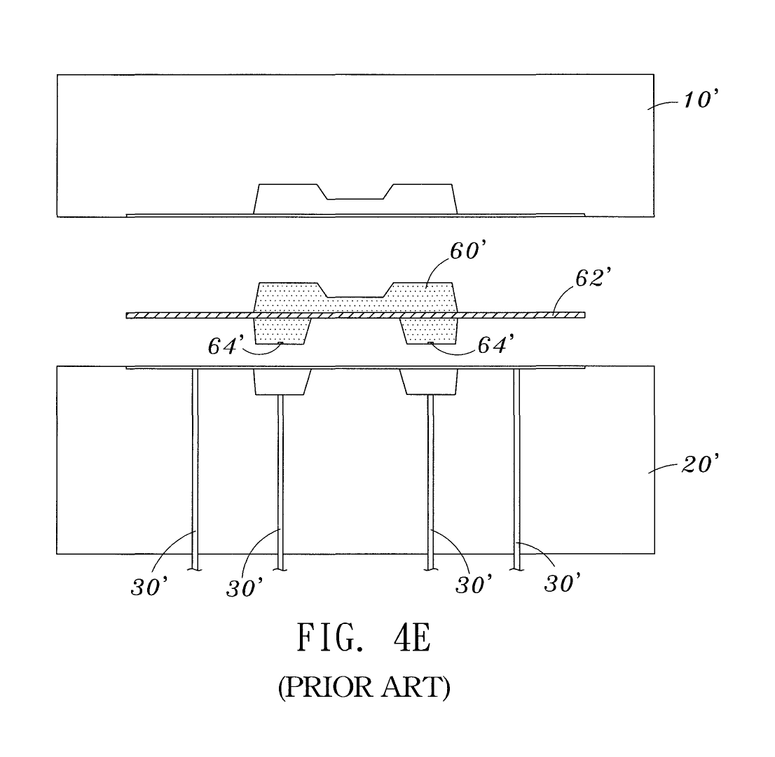

FIGS. 2A-2F are schematic views showing the continuous operation of the mold of the present invention during injection molding. When the mold is used to injection mold, the upper mold 10 and the lower mold 20 are closed. That is, the conveyer belt 62 is disposed in the grooves 12, 22 between the upper mold 10 and the lower molds 20. As shown in FIG. 2A, the upper mold 10 and the lower mold 20 are closed together, and the top surface of the movable ejection block 40 and the bottom of the upper mold 10 are also in a closed position. The melted plastic for the injection molding is injected into the cavities 14, 42 between the upper mold 10 and the movable ejection block 40 through the injection hole (not shown) for enabling the injection molding plastic to form an LED lampshade 60 on the surface of the conveyer belt 62, as shown in FIG. 2B. When the injection is finished and after the LED lampshade 60 is slightly cooled, the mold is opened. The upper mold 10 is moved upwards relative to the lower mold 20 and so away from the lower mold 20, as shown in FIG. 2C. The ejection rods 30 and the movable ejection block 40 eject and move the conveyer belt 62 and the LED lampshade 60 toward the top of the lower mold 20 at a proper distance d at the same speed and in the same direction, as shown in FIG. 2D. After the conveyer belt 62 and the LED lampshade 60 are reached and positioned, the movable ejection block 40 moves downward and returns to its original position and leaves the surface of the LED lampshade 60, as shown in FIG. 2E. After the movable ejection block 40 returns to the original position, the ejection rods 30 disengage from the surface of the conveyer belt 62 and move downwards to return to their original position, as shown in FIG. 2F. Therefore, the LED lampshade 60 is disengaged from the mold and taken out.

The mold of the present invention for making an LED lampshade at least has the following advantages:

1. The surface of the LED lampshade 60 is in direct contact with the movable ejection block 40, and the LED lampshade disengages from the mold by being ejected by the movable ejection block 40. Since there is surface contact between the LED lampshade 60 and the movable ejection block 40, no ejection marks will formed on the surface of the LED lampshade 60 thereby preventing adverse deformations and colorations on the surface of the LED lampshade.

2. Since the LED lampshade 60 disengages from the mold by being ejected by the movable ejection block 40 in a manner of surface contact, the surface of the LED lampshade 60 has uniform stress exerted along the surface when the LED lampshade 60 disengages from the movable ejection block 40 thereby preventing deformation or damage to the LED lampshade 60 due to uneven stress on the surface of the LED lampshade 60.

The preferred embodiments, aspects, and features of the invention have been described in detail. It will be apparent to those skilled in the art that numerous variations, modifications, and substitutions may be made without departing from the spirit of the invention as disclosed and further claimed below.

What is claimed is:

1. A mold for an LED lampshade comprising:
an upper mold defined with a cavity in the bottom surface thereof;
a lower mold defined with a slide recess corresponding to the cavity of the upper mold, a movable ejection block being received in the slide recess, the movable ejection block being movable back and forth along the slide recess, a cavity being defined in the top surface of the movable ejection block, the surface of the cavity of the movable ejection block fittingly receiving the lower surface of the LED lampshade; and
multiple ejection rods respectively disposed on the lower mold and at opposite sides of the movable ejection block and extending from the bottom of the lower mold to the top of the lower mold.

2. The mold for an LED lampshade as claimed in claim 1, wherein the movable ejection block is disposed with a driving member at the bottom thereof, the driving member drives the movable ejection block to move back and forth in a direction perpendicular to the top of the lower mold and along the slide recess.

3. The mold for an LED lampshade as claimed in claim 2, wherein the driving member is an oil cylinder, an air cylinder or a spring.

4. The mold for an LED lampshade as claimed in claim 1, wherein a groove is formed between the upper and lower molds for receiving a conveyer belt.
